(19) United States
(12) Patent Application Publication
(10) Pub. No.: US 2016/0049883 A1
(43) Pub. Date: Feb. 18, 2016

(54) Power-Balancing Circuits for Stacked Topologies

(71) Applicant: Google Inc., Mountain View, CA (US)

(72) Inventors: Leo Francis Casey, San Francisco, CA (US); Andrew David Goessling, Oakland, CA (US)

(21) Appl. No.: 14/586,242

(22) Filed: Dec. 30, 2014

Related U.S. Application Data
(60) Provisional application No. 62/037,591, filed on Aug. 14, 2014.

(51) Int. Cl. H02M 7/217

(52) U.S. Cl. CPC H02M 7/217

(57) ABSTRACT

In one aspect, a method is described. The method may include operating a plurality of circuit elements, and operating a plurality of magnetically-coupled power-balancing circuits. Each individual power-balancing circuit may be electrically coupled in parallel to a respective circuit element and each individual power-balancing circuit may include a first switch and a second switch (or perhaps more than two switches). The method may include designating one power-balancing circuit of the plurality of power-balancing circuits as a primary power-balancing circuit, and alternately toggling the first switch and the second switch of the primary power-balancing circuit in accordance with a first duty cycle.

### BACKGROUND

Unless otherwise indicated herein, the materials described in this section are not prior art to the claims in this application and are not admitted to be prior art by inclusion in this section.

Various components of a vehicle system (as well as other types of systems), such as motors, may be arranged in series to form a stacked topology. Stacked topologies are often advantageous because they present certain efficiencies.

### SUMMARY

Methods and systems for balancing the power among components of a system, such as an aerial vehicle system, are described herein.

In one aspect, a method is described. The method may include operating a plurality of circuit elements. Each circuit element may be a power source that produces power or a power sink that consumes power. The method may further include operating a plurality of magnetically-coupled power-balancing circuits. Each individual power-balancing circuit may be electrically coupled in parallel to a respective circuit element and each individual power-balancing circuit may include a first switch and a second switch. Operating the plurality of power-balancing circuits may include designating one power-balancing circuit of the plurality of power-balancing circuits as a primary power-balancing circuit, and alternately toggling the first switch and the second switch of the primary power-balancing circuit in accordance with a first duty cycle.

In another respect, a system is disclosed. The system may include a plurality of circuit elements. Each circuit element may be a power source that produces power or a power sink that consumes power. The system may also include a plurality of magnetically-coupled power-balancing circuits. Each individual power-balancing circuit may be electrically coupled in parallel to a respective circuit element and each individual power-balancing circuit may include a first switch and a second switch. The system may additionally include a controller coupled to each power-balancing circuit. The controller may be configured to designate one power-balancing circuit of the plurality of power-balancing circuits as a primary power-balancing circuit, and alternately toggle the first switch and the second switch of the primary power-balancing circuit in accordance with a first duty cycle.

In another respect, another method is provided. The method may include operating a plurality of circuit elements. Each circuit element may be a power source that produces power or a power sink that consumes power. The method may also include operating a plurality of power-balancing circuits. Each individual power-balancing circuit may be electrically coupled in parallel to a respective circuit element and each individual power-balancing circuit may include a first switch and a second switch. Operating the plurality of power-balancing circuits may include alternately toggling the first switch and the second switch of each power-balancing circuit such that at any given time, the first switch of each power-balancing circuit is toggled on while the second switch of each power-balancing switch is toggled off or the first switch of each power-balancing circuit is toggled off while the second switch of each power-balancing switch is toggled on.

In yet another aspect, another system is disclosed. The system may include a plurality of circuit elements. Each circuit element may be a power source that produces power or a power sink that consumes power. The system may also include a plurality of power-balancing circuits. Each individual power-balancing circuit may be electrically coupled in parallel to a respective circuit element and each individual power-balancing circuit may include a first switch and a second switch. The system may additionally include a controller coupled to each power-balancing circuit. The controller may be configured to alternately toggling the first switch and the second switch of each power-balancing circuit such that at any given time, the first switch of each power-balancing circuit is toggled on while the second switch of each power-balancing switch is toggled off or the first switch of each power-balancing circuit is toggled off while the second switch of each power-balancing switch is toggled on.

These as well as other aspects, advantages, and alternatives, will become apparent to those of ordinary skill in the art by reading the following detailed description, with reference where appropriate to the accompanying drawings.

### BRIEF DESCRIPTION OF THE FIGURES

FIG. 1 depicts an Airborne Wind Turbine (AWT), according to an example embodiment.

FIG. 2 is a simplified block diagram depicting components of an AWT, according to an example embodiment.

FIG. 3 depicts an example circuit according to an example embodiment.

FIG. 4 depicts another example circuit according to an example embodiment.

FIG. 5 depicts another example circuit according to an example embodiment.

FIG. 6 depicts a flowchart of a method according to an example embodiment.

FIG. 7 depicts a flowchart of a method according to an example embodiment.

### DETAILED DESCRIPTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed methods and systems can be arranged and combined in a wide variety of different configurations, all of which are contemplated herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. OVERVIEW

Illustrative embodiments relate to example power-balancing circuits and corresponding control methods. The control methods may be used to operate the power-balancing circuits in such a way so as to move power away from one circuit element and to another circuit element. This may be useful when circuit elements are arranged in stacked topologies. However, the methods may be useful for circuit elements arranged in other topologies as well, including being electrically isolated from one another.

In a first example arrangement, power-balancing circuits may be embodied as half-bridge converters, which may include two switches and split-bus capacitors, and may be magnetically coupled via a shared set of series-wound magnetics. Each power-balancing circuit may be electrically coupled in parallel to a respective circuit element, such as a motor or generator.

In a second example arrangement, power-balancing circuits may be embodied as two switches with an output leg coupled between them. The output legs of any two power-balancing circuits may be coupled together through a capacitor. In this arrangement, each power-balancing circuit may also be electrically coupled in parallel to a respective circuit element, such as a motor or generator.

In an example control method for the first example arrangement, one power-balancing circuit may be designated as the primary power-balancing circuit. The switches of the primary power-balancing circuit may be alternately toggled according to a particular duty cycle while the switches of the other power-balancing circuits may be operated as passive rectifiers. Alternatively, the switches of the primary power-balancing circuit may be alternately toggled according to a first duty cycle while the switches of the other power-balancing circuits may also be alternately toggled according to a duty cycle, albeit with a shift in phase from the first duty cycle.

In an example control method for the second example arrangement, a first switch of each power-balancing circuit may be toggled on while the second switch of each power-balancing circuit is toggled off. Then, the first switch of each power-balancing circuit may be toggled off while the second switch of each power-balancing circuit is toggled on. This alternate toggling may repeat according to a particular duty cycle.

It should be understood that the above examples are provided for illustrative purposes, and should not be construed as limiting. As such, the method may additionally or alternatively include other features or include fewer features, without departing from the scope of the invention.

### II. EXAMPLE SYSTEMS

### A. Example Airborne Wind Turbine (AWT)

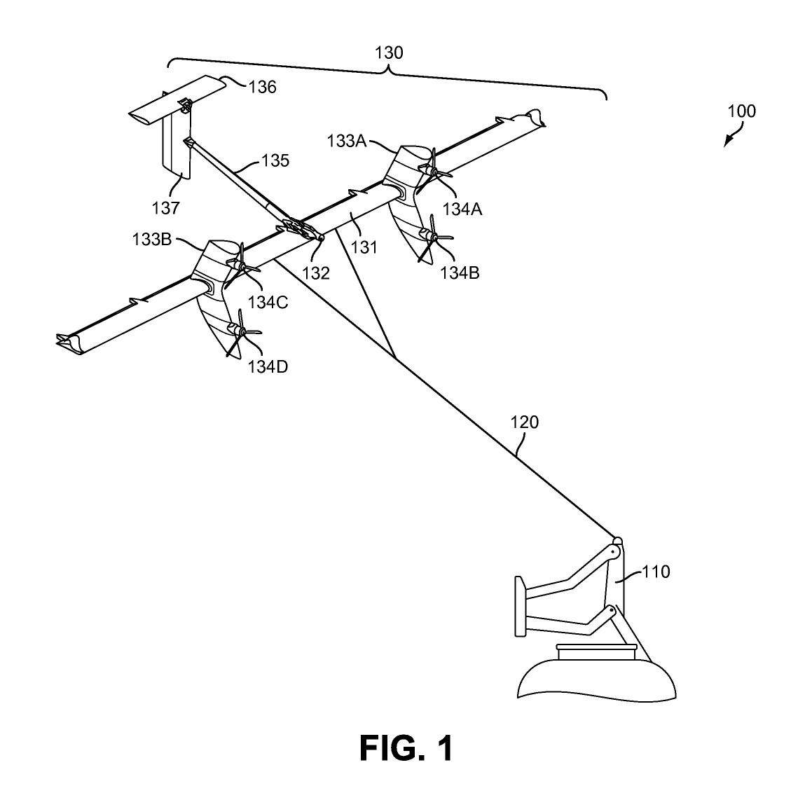

FIG. 1 depicts an AWT 100, according to an example embodiment. In particular, the AWT 100 includes a ground station 110, a tether 120, and an aerial vehicle 130. As shown in FIG. 1, the aerial vehicle 130 may be connected to the tether 120, and the tether 120 may be connected to the ground station 110. In this example, the tether 120 may be attached to the ground station 110 at one location on the ground station 110, and attached to the aerial vehicle 130 at two locations on the aerial vehicle 130. However, in other examples, the tether 120 may be attached at multiple locations to any part of the ground station 110 and/or the aerial vehicle 130.

The ground station 110 may be used to hold and/or support the aerial vehicle 130 until it is in an operational mode. The ground station 110 may also be configured to allow for the repositioning of the aerial vehicle 130 such that deploying of the device is possible. Further, the ground station 110 may be further configured to receive the aerial vehicle 130 during a landing. The ground station 110 may be formed of any material that can suitably keep the aerial vehicle 130 attached and/or anchored to the ground while in hover flight, forward flight, crosswind flight.

In addition, the ground station 110 may include one or more components (not shown), such as a winch, that may vary a length of the tether 120. For example, when the aerial vehicle 130 is deployed, the one or more components may be configured to pay out and/or reel out the tether 120. In some implementations, the one or more components may be configured to pay out and/or reel out the tether 120 to a predetermined length. As examples, the predetermined length could be equal to or less than a maximum length of the tether 120. Further, when the aerial vehicle 130 lands in the ground station 110, the one or more components may be configured to reel in the tether 120.

The tether 120 may transmit electrical energy generated by the aerial vehicle 130 to the ground station 110. In addition, the tether 120 may transmit electricity to the aerial vehicle 130 in order to power the aerial vehicle 130 for takeoff, landing, hover flight, and/or forward flight. The tether 120 may be constructed in any form and using any material which may allow for the transmission, delivery, and/or harnessing of electrical energy generated by the aerial vehicle 130 and/or transmission of electricity to the aerial vehicle 130. The tether 120 may also be configured to withstand one or more forces of the aerial vehicle 130 when the aerial vehicle 130 is in an operational mode. For example, the tether 120 may include a core configured to withstand one or more forces of the aerial vehicle 130 when the aerial vehicle 130 is in hover flight, forward flight, and/or crosswind flight. The core may be constructed of any high strength fibers. In some examples, the tether 120 may have a fixed length and/or a variable length. For instance, in at least one such example, the tether 120 may have a length of 140 meters.

The aerial vehicle 130 may be configured to fly substantially along a path to generate electrical energy. The term “substantially along,” as used in this disclosure, refers to exactly along and/or one or more deviations from exactly along that do not significantly impact generation of electrical energy as described herein and/or transitioning an aerial vehicle between certain flight modes as described herein.

The aerial vehicle 130 may include or take the form of various types of devices, such as a kite, a helicopter, a wing and/or an airplane, among other possibilities. The aerial vehicle 130 may be formed of solid structures of metal, plastic and/or other polymers. The aerial vehicle 130 may be formed of any material which allows for a high thrust-to-weight ratio and generation of electrical energy which may be used in utility applications. Additionally, the materials may be chosen to allow for a lightning hardened, redundant and/or fault tolerant design which may be capable of handling large and/or sudden shifts in wind speed and wind direction. Other materials may be possible as well.

As shown in FIG. 1, the aerial vehicle 130 may include a main wing 131, a front section 132, rotor connectors 133A-B, rotors 134A-D, a tail boom 135, a tail wing 136, and a vertical stabilizer 137. Any of these components may be shaped in any form which allows for the use of components of lift to resist gravity and/or move the aerial vehicle 130 forward.

The main wing 131 may provide a primary lift for the aerial vehicle 130. The main wing 131 may be one or more rigid or flexible airfoils, and may include various control surfaces, such as winglets, flaps, rudders, elevators, etc. The control surfaces may be used to stabilize the aerial vehicle 130 and/or reduce drag on the aerial vehicle 130 during hover flight, forward flight, and/or crosswind flight.

The main wing 131 may be any suitable material for the aerial vehicle 130 to engage in hover flight, forward flight, and/or crosswind flight. For example, the main wing 131 may include carbon fiber and/or e-glass. Moreover, the main wing 131 may have a variety dimensions. For example, the main wing 131 may have one or more dimensions that correspond with a conventional wind turbine blade. As another example, the main wing 131 may have a span of 8 meters, an area of 4 meters squared, and an aspect ratio of 15. The front section 132 may include one or more components, such as a nose, to reduce drag on the aerial vehicle 130 during flight.

The rotor connectors 133A-B may connect the rotors 134A-D to the main wing 131. In some examples, the rotor connectors 133A-B may take the form of or be similar in form to one or more pylons. In this example, the rotor connectors 133A-B are arranged such that the rotors 134A-D are spaced between the main wing 131. In some examples, a vertical spacing between corresponding rotors (e.g., rotor 134A and rotor 134B or rotor 134C and rotor 134D) may be 0.9 meters.

The rotors 134A-D may configured to drive one or more generators for the purpose of generating electrical energy. In this example, the rotors 134A-D may each include one or more blades, such as three blades. The one or more rotor blades may rotate via interactions with the wind and which could be used to drive the one or more generators. In addition, the rotors 134A-D may also be configured to provide a thrust to the aerial vehicle 130 during flight. With this arrangement, the rotors 134A-D may function as one or more propulsion units, such as a propeller. Although the rotors 134A-D are depicted as four rotors in this example, in other examples the aerial vehicle 130 may include any number of rotors, such as less than four rotors or more than four rotors.

The tail boom 135 may connect the main wing 131 to the tail wing 136. The tail boom 135 may have a variety of dimensions. For example, the tail boom 135 may have a length of 2 meters. Moreover, in some implementations, the tail boom 135 could take the form of a body and/or fuselage of the aerial vehicle 130. And in such implementations, the tail boom 135 may carry a payload.

The tail wing 136 and/or the vertical stabilizer 137 may be used to stabilize the aerial vehicle and/or reduce drag on the aerial vehicle 130 during hover flight, forward flight, and/or crosswind flight. For example, the tail wing 136 and/or the vertical stabilizer 137 may be used to maintain a pitch of the aerial vehicle 130 during hover flight, forward flight, and/or crosswind flight. In this example, the vertical stabilizer 137 is attached to the tail boom 135, and the tail wing 136 is located on top of the vertical stabilizer 137. The tail wing 136 may have a variety of dimensions. For example, the tail wing 136 may have a length of 2 meters. Moreover, in some examples, the tail wing 136 may have a surface area of 0.45 meters squared. Further, in some examples, the tail wing 136 may be located 1 meter above a center of mass of the aerial vehicle 130.

While the aerial vehicle 130 has been described above, it should be understood that the methods and systems described herein could involve any suitable aerial vehicle that is connected to a tether, such as the tether 120.

### B. Example Components of an AWT

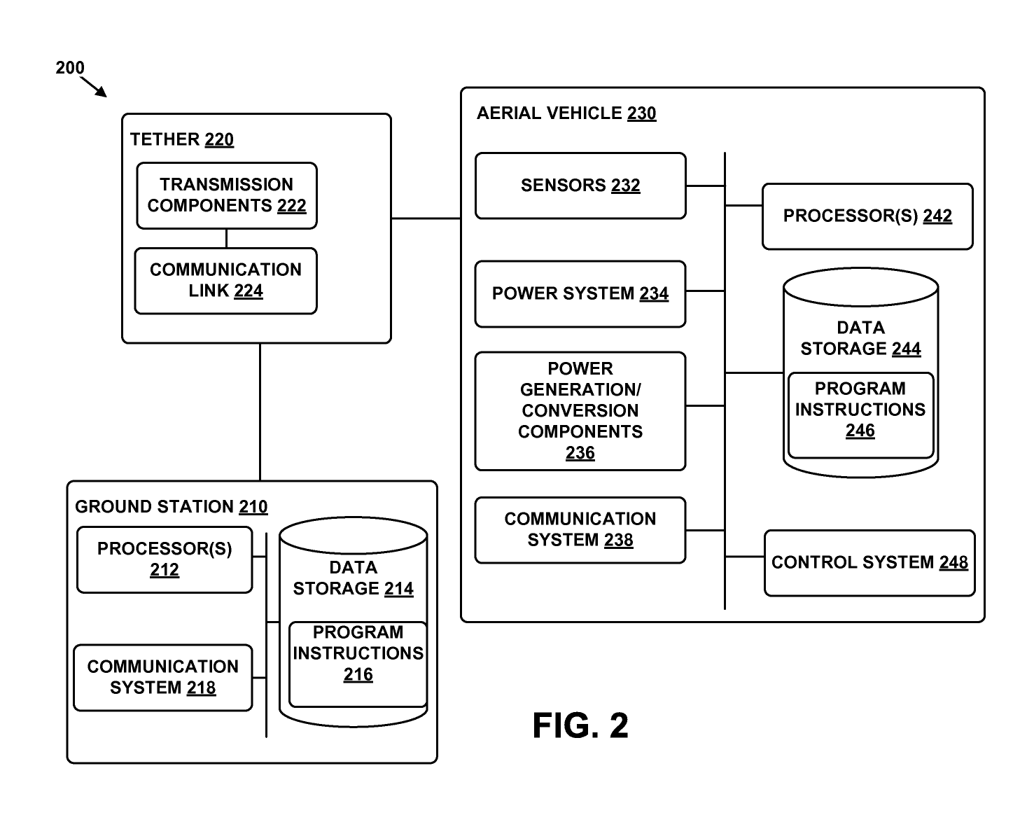

FIG. 2 is a simplified block diagram illustrating components of the AWT 200. The AWT 200 may take the form of or be similar in form to the AWT 100. In particular, the AWT 200 includes a ground station 210, a tether 220, and an aerial vehicle 230. The ground station 210 may take the form of or be similar in form to the ground station 110, the tether 220 may take the form of or be similar in form to the tether 120, and the aerial vehicle 230 may take the form of or be similar in form to the aerial vehicle 130.

As shown in FIG. 2, the ground station 210 may include one or more processors 212, data storage 214, and program instructions 216. A processor 212 may be a general-purpose processor or a special purpose processor (e.g., digital signal processors, application specific integrated circuits, etc.). The one or more processors 212 can be configured to execute computer-readable program instructions 216 that are stored in a data storage 214 and are executable to provide at least part of the functionality described herein.

The data storage 214 may include or take the form of one or more computer-readable storage media that may be read or accessed by at least one processor 212. The one or more computer-readable storage media can include volatile and/or non-volatile storage components, such as optical, magnetic, organic or other memory or disc storage, which may be integrated in whole or in part with at least one of the one or more processors 212. In some embodiments, the data storage 214 may be implemented using a single physical device (e.g., one optical, magnetic, organic or other memory or disc storage unit), while in other embodiments, the data storage 214 can be implemented using two or more physical devices.

As noted, the data storage 214 may include computer-readable program instructions 216 and perhaps additional data, such as diagnostic data of the ground station 210. As such, the data storage 214 may include program instructions to perform or facilitate some or all of the functionality described herein.

In a further respect, the ground station 210 may include a communication system 218. The communications system 218 may include one or more wireless interfaces and/or one or more wireline interfaces, which allow the ground station 210 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. The ground station 210 may communicate with the aerial vehicle 230, other ground stations, and/or other entities (e.g., a command center) via the communication system 218.

In an example embodiment, the ground station 210 may include communication systems 218 that allows for both short-range communication and long-range communication. For example, the ground station 210 may be configured for short-range communications using Bluetooth and for long-range communications under a CDMA protocol. In such an embodiment, the ground station 210 may be configured to function as a “hot spot”; or in other words, as a gateway or proxy between a remote support device (e.g., the tether 220, the aerial vehicle 230, and other ground stations) and one or more data networks, such as cellular network and/or the Internet. Configured as such, the ground station 210 may facilitate data communications that the remote support device would otherwise be unable to perform by itself.

For example, the ground station 210 may provide a Wi-Fi connection to the remote device, and serve as a proxy or gateway to a cellular service provider's data network, which the ground station 210 might connect to under an LTE or a 3G protocol, for instance. The ground station 210 could also serve as a proxy or gateway to other ground stations or a command station, which the remote device might not be able to otherwise access.

Moreover, as shown in FIG. 2, the tether 220 may include transmission components 222 and a communication link 224. The transmission components 222 may be configured to transmit electrical energy from the aerial vehicle 230 to the ground station 210 and/or transmit electrical energy from the ground station 210 to the aerial vehicle 230. The transmission components 222 may take various different forms in various different embodiments. For example, the transmission components 222 may include one or more conductors that are configured to transmit electricity. And in at least one such example, the one or more conductors may include aluminum and/or any other material which allows for the conduction of electric current. Moreover, in some implementations, the transmission components 222 may surround a core of the tether 220 (not shown).

The ground station 210 could communicate with the aerial vehicle 230 via the communication link 224. The communication link 224 may be bidirectional and may include one or more wired and/or wireless interfaces. Also, there could be one or more routers, switches, and/or other devices or networks making up at least a part of the communication link 224.

Further, as shown in FIG. 2, the aerial vehicle 230 may include one or more sensors 232, a power system 234, power generation/conversion components 236, a communication system 238, one or more processors 242, data storage 244, and program instructions 246, and a control system 248.

The sensors 232 could include various different sensors in various different embodiments. For example, the sensors 232 may include a global a global positioning system (GPS) receiver. The GPS receiver may be configured to provide data that is typical of well-known GPS systems (which may be referred to as a global navigation satellite system (GNNS)), such as the GPS coordinates of the aerial vehicle 230. Such GPS data may be utilized by the AWT 200 to provide various functions described herein.

As another example, the sensors 232 may include one or more wind sensors, such as one or more pitot tubes. The one or more wind sensors may be configured to detect apparent and/or relative wind. Such wind data may be utilized by the AWT 200 to provide various functions described herein.

Still as another example, the sensors 232 may include an inertial measurement unit (IMU). The IMU may include both an accelerometer and a gyroscope, which may be used together to determine the orientation of the aerial vehicle 230. In particular, the accelerometer can measure the orientation of the aerial vehicle 230 with respect to earth, while the gyroscope measures the rate of rotation around an axis, such as a centerline of the aerial vehicle 230. IMUs are commercially available in low-cost, low-power packages. For instance, the IMU may take the form of or include a miniaturized MicroElectroMechanical System (MEMS) or a NanoElectroMechanical System (NEMS). Other types of IMUs may also be utilized. The IMU may include other sensors, in addition to accelerometers and gyroscopes, which may help to better determine position. Two examples of such sensors are magnetometers and pressure sensors. Other examples are also possible.

While an accelerometer and gyroscope may be effective at determining the orientation of the aerial vehicle 230, slight errors in measurement may compound over time and result in a more significant error. However, an example aerial vehicle 230 may be able mitigate or reduce such errors by using a magnetometer to measure direction. One example of a magnetometer is a low-power, digital 3-axis magnetometer, which may be used to realize an orientation independent electronic compass for accurate heading information. However, other types of magnetometers may be utilized as well.

The aerial vehicle 230 may also include a pressure sensor or barometer, which can be used to determine the altitude of the aerial vehicle 230. Alternatively, other sensors, such as sonic altimeters or radar altimeters, can be used to provide an indication of altitude, which may help to improve the accuracy of and/or prevent drift of the IMU.

As noted, the aerial vehicle 230 may include the power system 234. The power system 234 could take various different forms in various different embodiments. For example, the power system 234 may include one or more batteries for providing power to the aerial vehicle 230. In some implementations, the one or more batteries may be rechargeable and each battery may be recharged via a wired connection between the battery and a power supply and/or via a wireless charging system, such as an inductive charging system that applies an external time-varying magnetic field to an internal battery and/or charging system that uses energy collected from one or more solar panels.

As another example, the power system 234 may include one or more motors or engines for providing power to the aerial vehicle 230. In some implementations, the one or more motors or engines may be powered by a fuel, such as a hydrocarbon-based fuel. And in such implementations, the fuel could be stored on the aerial vehicle 230 and delivered to the one or more motors or engines via one or more fluid conduits, such as piping. In some implementations, the power system 234 may be implemented in whole or in part on the ground station 210.

As noted, the aerial vehicle 230 may include the power generation/conversion components 236. The power generation/conversion components 326 could take various different forms in various different embodiments. For example, the power generation/conversion components 236 may include one or more generators, such as high-speed, direct-drive generators. With this arrangement, the one or more generators may be driven by one or more rotors, such as the rotors 134A-D. And in at least one such example, the one or more generators may operate at full rated power wind speeds of 11.5 meters per second at a capacity factor which may exceed 60 percent, and the one or more generators may generate electrical power from 40 kilowatts to 600 megawatts.

Moreover, as noted, the aerial vehicle 230 may include a communication system 238. The communication system 238 may take the form of or be similar in form to the communication system 218. The aerial vehicle 230 may communicate with the ground station 210, other aerial vehicles, and/or other entities (e.g., a command center) via the communication system 238.

In some implementations, the aerial vehicle 230 may be configured to function as a “hot spot”; or in other words, as a gateway or proxy between a remote support device (e.g., the ground station 210, the tether 220, other aerial vehicles) and one or more data networks, such as cellular network and/or the Internet. Configured as such, the aerial vehicle 230 may facilitate data communications that the remote support device would otherwise be unable to perform by itself.

For example, the aerial vehicle 230 may provide a WiFi connection to the remote device, and serve as a proxy or gateway to a cellular service provider's data network, which the aerial vehicle 230 might connect to under an LTE or a 3G protocol, for instance. The aerial vehicle 230 could also serve as a proxy or gateway to other aerial vehicles or a command station, which the remote device might not be able to otherwise access.

As noted, the aerial vehicle 230 may include the one or more processors 242, the program instructions 244, and the data storage 246. The one or more processors 242 can be configured to execute computer-readable program instructions 246 that are stored in the data storage 244 and are executable to provide at least part of the functionality described herein. The one or more processors 242 may take the form of or be similar in form to the one or more processors 212, the data storage 244 may take the form of or be similar in form to the data storage 214, and the program instructions 246 may take the form of or be similar in form to the program instructions 216.

Moreover, as noted, the aerial vehicle 230 may include the control system 248. In some implementations, the control system 248 may be configured to perform one or more functions described herein. The control system 248 may be implemented with mechanical systems and/or with hardware, firmware, and/or software. As one example, the control system 248 may take the form of program instructions stored on a non-transitory computer readable medium and a processor that executes the instructions. The control system 248 may be implemented in whole or in part on the aerial vehicle 230 and/or at least one entity remotely located from the aerial vehicle 230, such as the ground station 210. Generally, the manner in which the control system 248 is implemented may vary, depending upon the particular application.

### III. EXAMPLE POWER-BALANCING CIRCUITS

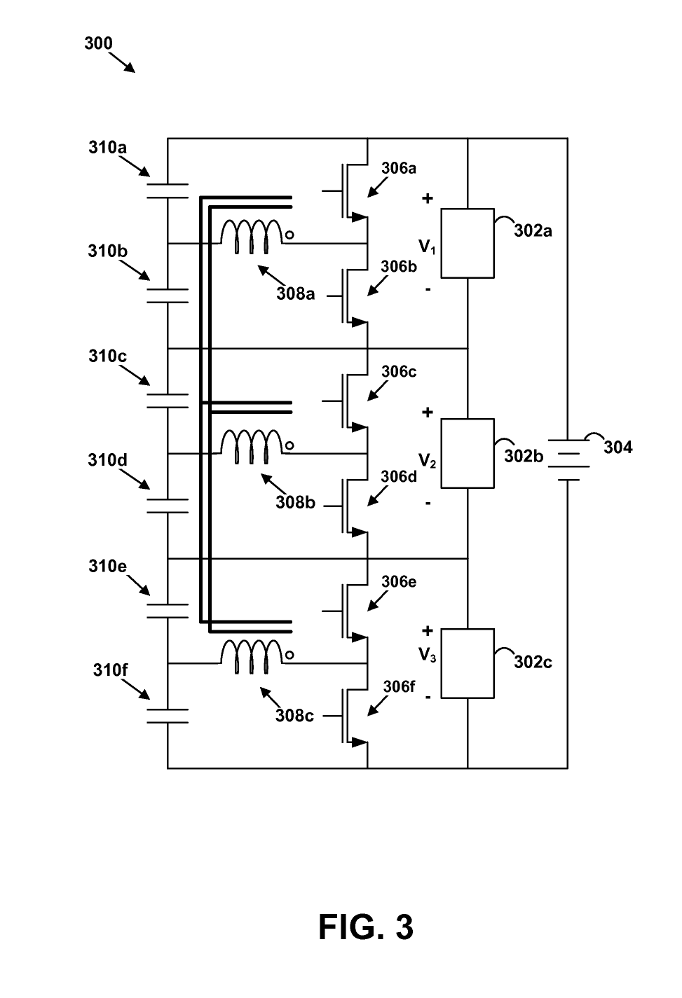

FIG. 3 illustrates an example circuit 300 in which power-balancing circuits may be used to balance the power produced or consumed by two or more circuit elements. Such elements may be components of an aerial vehicle, such as aerial vehicle 230 (FIG. 2). It should be understood that circuit 300 may depict just a portion of a larger circuit or system that may be used to facilitate operation of an aerial vehicle, an AWT system, or some other system altogether.

As depicted, circuit 300 includes a voltage source 304 and three circuit elements 302a-c coupled together in series to form a stack. It should be understood that the depiction of three circuit elements arranged in a stack is just an example, and in other examples more or fewer circuit elements may be arranged in a stack, or the circuit elements may not be arranged in stacks at all, perhaps even being electrically isolated from one another. In some embodiments, the circuit elements are power sources, meaning that each element 302a-c produces power; in other embodiments, the circuit elements are power sinks, meaning that each element 302a-c consumes power; and in still other embodiments, circuit elements 302a-c are a combination of power sources and power sinks in which at least one element 302a-c produces power and at least one element 302a-c consumes power. Thus, elements 302a-c may be similar to components of power system 234 (FIG. 2), such as one or more motors or engines powered by a fuel, such as a hydrocarbon-based fuel. Additionally or alternatively, elements 302a-c may be similar to components of control system 248 (FIG. 2), such as a wing servo or other control motor.

In accordance with one example arrangement of power-balancing circuits in FIG. 3, three power-balancing circuits are provided in parallel to the stacked circuit elements 302a-c. More particularly, a first power-balancing circuit is coupled in parallel to element 302a and is embodied as a half-bridge converter that includes two switches 306a-b, a set of shared series-wound magnetics 308a, and two split-bus capacitors 310a-b. Similarly, a second power-balancing circuit is coupled in parallel to element 302b and is also embodied as a half-bridge converter that includes two switches 306c-d, a set of shared series-wound magnetics 308b, and two split-bus capacitors 310c-d. And similarly, a third power-balancing circuit is coupled in parallel to element 302c and is also embodied as a half-bridge converter that includes two switches 306e-f, a set of shared series-wound magnetics 308c, and two split-bus capacitors 310e-f. However, in an alternative implementation of circuit 300, each split-bus capacitor 310a-f may be replaced with an active switch in order to form a set of three full-bridge converters.

As depicted in FIG. 3, the switches of each power-balancing circuit are embodied as MOSFETs, however in other embodiments, the switches may be other types of devices. Moreover, it should be understood that in other embodiments, other arrangements may include more or fewer power-balancing circuits, depending on the number of circuit elements for which it is desired to balance power.

In order to utilize the power-balancing circuits to balance the power produced or consumed by the element 302a-c in the stack, the switches 306a-f may be selectively operated in accordance with one or more example control methods. In operation according to these control methods, power will be shifted away from one or more circuit elements to one or more other circuit elements. Advantageously, in embodiments in which circuit elements are electrically isolated, the power-balancing circuits can be utilized to arbitrarily move power from one element to another element. And in embodiments in which circuit elements are arranged in stacked topologies, the power-balancing circuits can be utilized to balance the power at each stage of the stack. Power-balancing circuits may be utilized in other ways as well.

Although not shown in FIG. 3 for sake of brevity, each switch 306a-f may be coupled to a controller, such as processors 242 (FIG. 2) to facilitate operation of the switches 306a-f. For instance, in embodiments in which the switches 306a-f are implemented with MOSFETs, the gate portion of each MOSFET may be separately coupled to the controller; however, in embodiments in which the switches 306a-f are implemented with some other type of device, the appropriate portion of those devices may be coupled to the controller to facilitate operation of the switches.

In accordance with a first example control method, one of the power-balancing circuits is designated as the primary power-balancing circuit and the remaining power-balancing circuits are designated as secondary power-balancing circuits. The two switches of the primary power-balancing circuit may be alternately toggled in accordance with a particular duty cycle (e.g., a 50% duty cycle) while the switches of the secondary power-balancing circuits may be operated as passive rectifiers. That is, the first switch of the primary power-balancing circuit may be toggled on while the second switch of the power-balancing circuit may be toggled off. Sometime later (e.g., 0.5 switching cycles later), the first switch may be toggled off while the second switch may be toggled on. And sometime later again (e.g., 0.5 switching cycles later), the first switch may be toggled back on while the second switch may be toggled back off. This alternate toggling process may continue for so long as it is desired to balance the power among the circuit elements.

In the example circuit 300 depicted in FIG. 3, if the first power-balancing circuit is designated as the primary power-balancing circuit, then switches 306a and 306b may be alternately toggled back and forth according to a particular duty cycle, whereas switches 306c, 306d, 306e, and 306f may be used as passive rectifiers. In another example, if the second power-balancing circuit is designated as the primary power-balancing circuit, then switches 306c and 306d may be alternately toggled back and forth according to a particular duty cycle, whereas switches 306a, 306b, 306e, and 306f may be used as passive rectifiers.

In some implementations of this control method, the designated primary power-balancing circuit may change from one power-balancing circuit to another. In one example, whichever power-balancing circuit is coupled in parallel to the circuit element producing the greatest amount of power (i.e., the largest power source, or the smallest power sink, as the case may be) may be designated the primary power-balancing circuit, and the remaining power-balancing circuits may be designated as the secondary power-balancing circuits. In operation according to this example, from time to time, and perhaps every cycle, a controller, such as processors 242 (FIG. 2) may measure the voltage across each circuit element to determine which voltage is greatest. Thus, in the example arrangement depicted in FIG. 3, when V₁ is larger than V₂ and V₃, the first power-balancing circuit may be designated as the primary power-balancing circuit, whereas the second and third power-balancing circuits may be designated as the secondary power-balancing circuits. In another case, when V₂ is larger than V₁ and V₃, the second power-balancing circuit may be designated as the primary power-balancing circuit, whereas the first and third power-balancing circuits may be designated as the secondary power-balancing circuits. And in another case, when V₃ is larger than V₁ and V₂, the third power-balancing circuit may be designated as the primary power-balancing circuit, whereas the first and second power-balancing circuits may be designated as the secondary power-balancing circuits. However, other methods for determining which power-balancing circuit is producing the greatest amount of power are possible as well.

In another example, the designated primary power-balancing circuit may change from one power-balancing circuit to another without respect to the voltage across the circuit elements. In operation according to this example, the controller may loop through and alternately designate each power-balancing circuit as the primary at different times. Thus, in the example arrangement depicted in FIG. 3, the first power-balancing circuit may be designated as the primary and the second and third power-balancing circuits may be designated as the secondaries. After a particular number of cycles of alternately toggling the switches of the primary power-balancing circuit (e.g., one cycle), the controller may designate the second power-balancing circuit as the primary and the first and third power-balancing circuits as the secondaries. The controller may loop through in this manner, alternately designating each power-balancing circuit as the primary in turn, for so long as it is desired to balance the power among the circuit elements.

In embodiments in which the switches are implemented with MOSFETs, the controller may toggle a MOSFET on by applying a particular voltage (e.g., 8.0 V) between the gate and source terminals of the MOSFET and toggle a MOSFET off by removing the application of voltage between the gate and source terminals and/or by applying a lesser voltage (e.g., 0.5 V) between the gate and source terminals of the MOSFET, such that the voltage is below the “threshold” of the device. Thus, in order to alternately toggle switches (e.g., switches 306a and 306b) according to a duty cycle, the controller may cycle back and forth between alternate application and de-application of the particular voltage to each switch. The ratio of the amount of time one switch is toggled on (e.g., switch 306a) to the amount of time the other switch is toggled on (e.g., switch 306b) defines the duty cycle. For instance, a 50% duty cycle dictates that over the course of a switching cycle, the amount of time one switch is toggled on is about equal to the amount of time that the other switch is toggled on. On the other hand a duty cycle of, say, 75% dictates that over the course of a switching cycle, the amount of time one switch is toggled on (e.g., switch 306a) is about three times longer than the amount of time the other switch (e.g., switch 306b) is toggled on. Other duty cycles are possible as well.

In embodiments in which the switches are implemented with MOSFETs, the controller may operate the MOSFET as a passive rectifier by toggling each MOSFET off (e.g., removing the application of voltage between the gate and source terminals and/or by applying a lesser voltage (e.g., 0.5 V) between the gate and source terminals of the MOSFET), thereby using the inherent diode within the device. Other ways to operate a switch as a passive rectifier are possible as well.

In accordance with a second example control method for the power-balancing circuit arrangement depicted in FIG. 3, the two switches of one power-balancing circuit may be alternately toggled in accordance with a particular duty cycle (e.g., a 50% duty cycle) while the switches of another power-balancing circuit (and perhaps the switches of all power-balancing circuits) may also be alternately toggled in accordance with a duty cycle (e.g., a 50% duty cycle) albeit with a shift in phase with respect to the first circuit. Thus, in the example circuit 300, switches 306a and 306b may alternately toggled, and the switches 306c and 306d may also be alternately toggled but not toggled at the same time as switches 306a and 306b are toggled. One advantage (of perhaps many) of this control method is that it may be used to transfer power between elements that have voltages of equal magnitude.

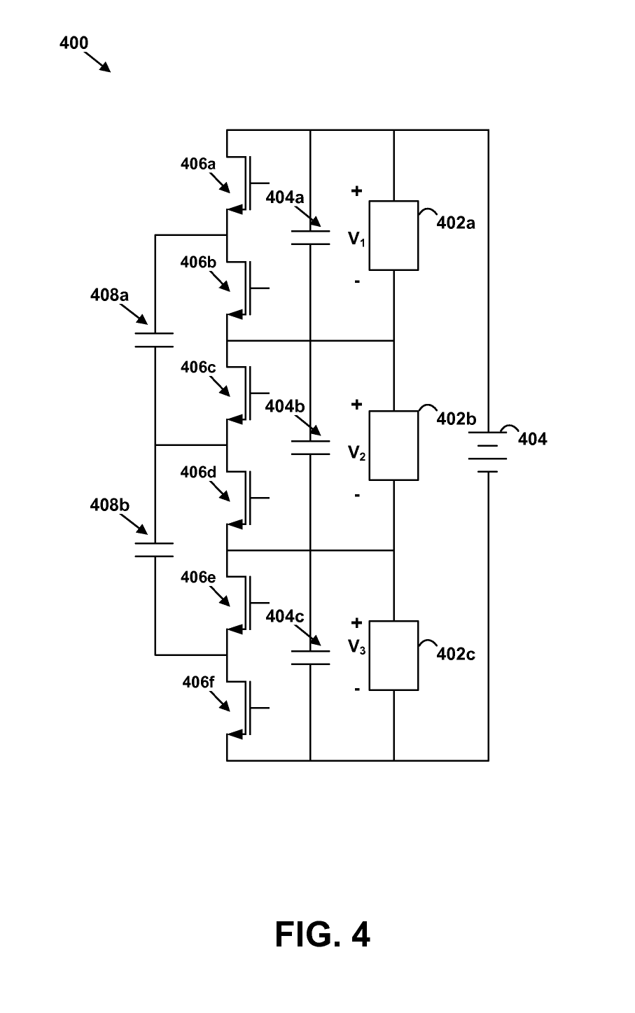

FIG. 4 depicts an alternate arrangement of power-balancing circuits that may utilize a capacitive technique to balance power among circuit elements. As depicted, circuit 400 includes a voltage source 404 and three circuit elements 402a-c coupled together in series to form a stack. It should be understood that like the arrangement depicted in FIG. 3, the depiction of three circuit elements arranged in a stack in FIG. 4 is just an example, and in other examples more or fewer circuit elements may be arranged in a stack, or the circuit elements may not be arranged in stacks at all, perhaps sharing just a common reference. Like FIG. 3, the circuit elements 402a-c may be some combination of power sources and power sinks. As depicted, a first power-balancing circuit is coupled in parallel to element 402a and includes two switches 406a-b and coupled in parallel thereto a capacitor 404a. Similarly, a second power-balancing circuit is coupled in parallel to element 402b and includes two switches 406c-d and coupled in parallel thereto a capacitor 404b. And similarly, a third power-balancing circuit is coupled in parallel to element 402c and includes two switches 406e-f and coupled in parallel thereto a capacitor 404c. Finally, each power-balancing circuit includes an output leg coupled between the switches of the power-balancing circuit. In the circuit 400, capacitor 408a is positioned between the output leg of the first power-balancing circuit and the output leg of the second power-balancing circuit, and capacitor 408b is positioned between the output leg of the second power-balancing circuit and the output leg of the third power-balancing circuit.

Similar to that depicted above in FIG. 3, the switches of each power-balancing circuit of FIG. 4 are embodied as MOSFETs, however in other embodiments, the switches may be other types of devices. And although not shown in FIG. 4 for sake of brevity, each switch 406a-f may be coupled to a controller, such as processors 242 (FIG. 2) to facilitate operation of the switches 406a-f. For instance, in embodiments in which the switches 406a-f are implemented with MOSFETs, the gate portion of each MOSFET may be separately coupled to the controller; however, in embodiments in which the switches 406a-f are implemented with some other type of device, the appropriate portion of those devices may be coupled to the controller to facilitate operation of the switches. Moreover, it should be understood that in other embodiments, other circuits may include more or fewer power-balancing circuits, depending on the number of circuit elements in the arrangement.

In order to balance power among the circuit elements utilizing the arrangement depicted in FIG. 4, the power-balancing circuits may be operated in accordance with a third control method. Here, the switches of each power-balancing circuit are at the same time alternately toggled in accordance with a particular duty cycle (e.g., a 50% duty cycle). That is, switches 406a, 406c, and 406e may be toggled on while the other switches 406b, 406d, and 406f may be toggled off. Sometime later (e.g., 0.5 switching cycles later) switches 406a, 406c, and 406e may be toggled off while the other switches 406b, 406d, and 406f may be toggled on. This alternate toggling process may continue for so long as it is desired to balance the power among the circuit elements.

As a result of the operation according to the third control method, charge may be shifted between any power-balancing circuits that have a capacitor coupled between respective output legs. Thus, in circuit 400 of FIG. 4, charge may be shifted between the first power-balancing circuit and the second power-balancing circuit, and charge may be shifted between the second power-balancing circuit and the third-power-balancing circuit. In order to shift charge between the first power-balancing circuit and the third power-balancing circuit, charge would be transferred first from the first power-balancing circuit to the second power-balancing circuit and then from the second power-balancing circuit to the third power-balancing circuit (or in the opposite direction, that is, from the third power-balancing circuit to the first power-balancing circuit through the second power-balancing circuit).

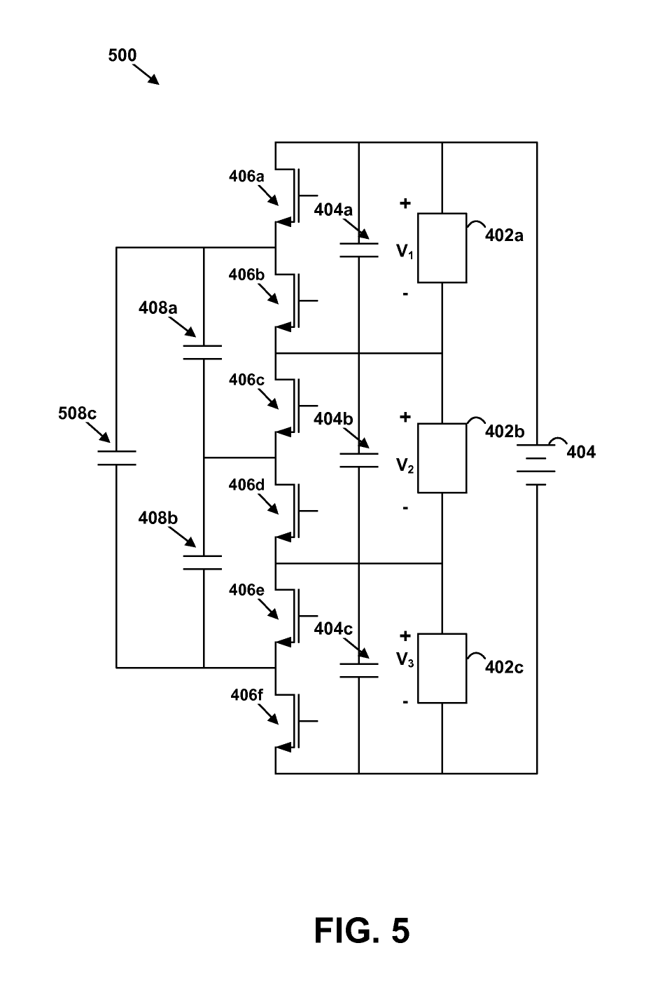

FIG. 5 depicts a circuit 500, which is an alternate arrangement of circuit 400. Circuit 500 is chiefly the same as circuit 400, however circuit 500 includes a capacitor 508c positioned between output legs of the first power-balancing circuit and the third power-balancing circuit. In this way, as a result of operation according to the third example control method described above, charge may be shifted directly between the first power-balancing circuit and the third power-balancing circuit, thereby achieving a balance among the circuit elements faster than with circuit 400 of FIG. 4.

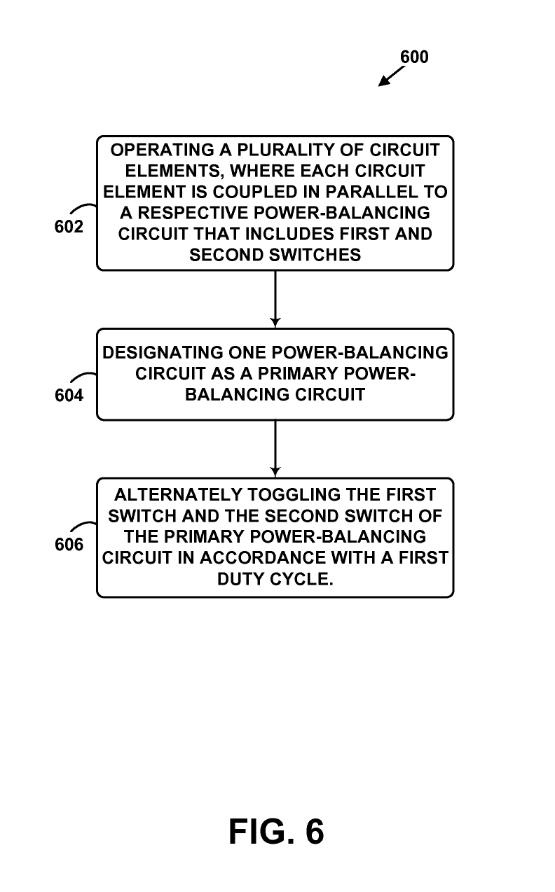

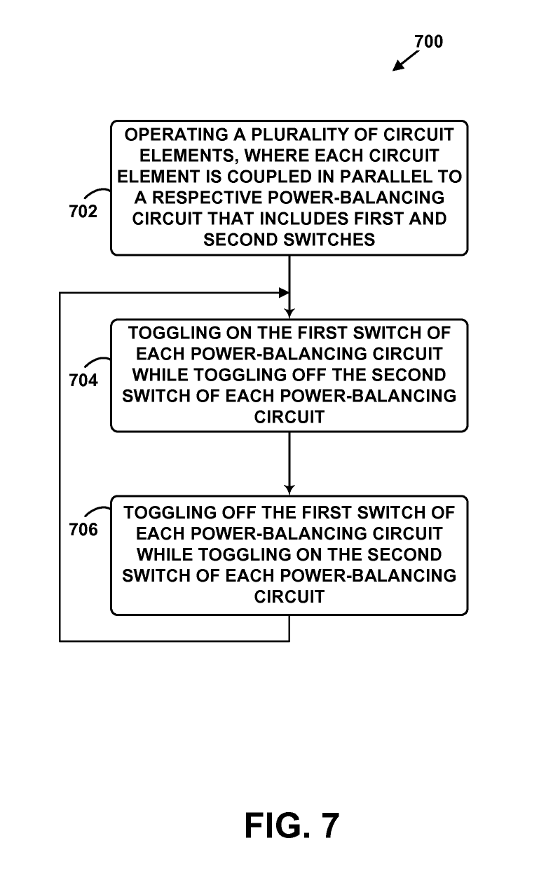

FIGS. 6 and 7 are flowcharts of example methods 600 and 700 that could be used to balance the power among circuit elements of various arrangements, including in a stacked topology. The example methods 600 and 700 may include one or more operations, functions, or actions, as depicted by one or more of blocks 602, 604, 606, 702, 704, and/or 706, each of which may be carried out by any of the systems described by way of FIGS. 1-5; however, other configurations could be used.

Furthermore, those skilled in the art will understand that the flowcharts described herein illustrate functionality and operation of certain implementations of example embodiments. In this regard, each block of each flow diagram may represent a module, a segment, or a portion of program code, which includes one or more instructions executable by a processor for implementing specific logical functions or steps in the process. The program code may be stored on any type of computer readable medium, for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

Method 600 begins at block 602, which includes operating a plurality of circuit elements, where each circuit element is coupled in parallel to a respective power-balancing circuit that includes first and second switches. As described above, in some embodiments the circuit elements may include some combination of power sources and/or power sinks. These circuit elements may be portions of an AWT (as well as portions of other types of systems), such as motors and/or generators. As also described above, the power-balancing circuits may be respective half-bridge converters magnetically coupled together with a shared set of series-wound magnetics. Each power-balancing circuit may therefore include a first switch and a second switch.

Method 600 continues at block 604, which includes designating one of the power-balancing circuits as a primary power-balancing circuit. As described above, in one example embodiment, a given power-balancing circuit may be designated as a primary power-balancing circuit when it is coupled in parallel to a circuit element that is producing the greatest amount of power. To carry out this designation, a controller may periodically measure the voltage across each circuit element and designate as a primary power-balancing circuit whichever power-balancing circuit is coupled in parallel to the circuit element with the highest voltage. However, other ways to determine which circuit element is producing the greatest amount of power are possible as well. In another example embodiment, a given power-balancing circuit may be designated as a primary power-balancing circuit for other reasons. For example, the controller may loop through designating each power-balancing circuit as a primary power-balancing circuit one at a time. Other ways to designate a primary power-balancing circuit are possible as well.

Method 600 continues at block 606, which includes alternately toggling the first switch and the second switch of the primary power-balancing circuit in accordance with a first duty cycle. As described above, alternately toggling each switch of a power-balancing circuit in accordance with a duty cycle may include first toggling on the first switch while toggling off the second switch, and then second, toggling off the first switch while toggling on the second switch.

Although not shown on the flowchart of FIG. 6, in one embodiment method 600 may also include operating the switches of the other power-balancing circuits (i.e., power-balancing circuits that are not designated as the primary power-balancing circuit) as passive rectifiers. As described above, when the switches are implemented with MOSFETs, operating the switches as passive rectifiers may include toggling the MOSFETs off thereby using the diode inherent in each MOSFET. In another embodiment, method 600 may also include alternately toggling the first switch and the second switch of another power-balancing circuit (i.e., a power-balancing circuit that is not designated as the primary power-balancing circuit) in accordance with a second duty cycle shifted in phase from the first duty cycle.

Turning to FIG. 7, method 700 begins at block 702, which includes operating a plurality of circuit elements, where each circuit element is coupled in parallel to a respective power-balancing circuit that includes first and second switches. As described above with respect to block 602 (FIG. 6), in some embodiments the circuit elements may include some combination of power sources and/or power sinks. These circuit elements may be portions of an AWT (as well as portions of other types of systems), such as motors and/or generators. The power-balancing circuits in this method may include two switches and coupled in parallel thereto a capacitor. Additionally, each power-balancing circuit may include an output leg coupled between the switches of the power-balancing circuit. Output legs of any two power-balancing circuits may be coupled together and may include a capacitor coupled between them.

Method 700 continues at block 704, which includes toggling on the first switch of each power-balancing circuit while toggling off the second switch of each power-balancing circuit. Continuing at block 706, the method includes toggling off the first switch of each power-balancing circuit while toggling on the second switch of each power-balancing circuit. Following block 706, flow may continue back at block 704 and continue in this manner for so long as it is desired to balance power among the circuit elements. In addition to the operations depicted in FIGS. 6 and 7, other operations may be utilized with the example power-balancing circuit arrangements presented herein.

### IV. CONCLUSION

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A method comprising:
operating a plurality of circuit elements, wherein each circuit element is a power source that produces power or a power sink that consumes power; and
operating a plurality of magnetically-coupled power-balancing circuits, each individual power-balancing circuit being electrically coupled in parallel to a respective circuit element and each individual power-balancing circuit including a first switch and a second switch, wherein operating the plurality of power-balancing circuits comprises:
designating one power-balancing circuit of the plurality of power-balancing circuits as a primary power-balancing circuit; and
alternately toggling the first switch and the second switch of the primary power-balancing circuit in accordance with a first duty cycle.

2. The method of claim 1, wherein operating the plurality of power-balancing circuits further comprises:
operating as passive rectifiers the first switch and the second switch of each power-balancing circuit not designated as the primary power-balancing circuit.

3. The method of claim 1, wherein operating the plurality of power-balancing circuits further comprises:
alternately toggling the first switch and the second switch of a power-balancing circuit not designated as the primary power-balancing circuit in accordance with a second duty cycle, the second duty cycle being shifted in phase from the first duty cycle.

4. The method of claim 1, wherein designating one power-balancing circuit of the plurality of power-balancing circuits as a primary power-balancing circuit comprises:
identifying a particular circuit element that is producing a greatest power; and
designating as the primary power-balancing circuit a particular power-balancing circuit that is coupled in parallel to the identified particular circuit element.

5. The method of claim 1, wherein operating the plurality of power-balancing circuits further comprises:
subsequent to alternately toggling the first switch and the second switch of the primary power-balancing circuit, designating a different power-balancing circuit of the plurality of power-balancing circuits as a new primary power-balancing circuit; and
alternately toggling the first switch and the second switch of the new primary power-balancing circuit in accordance with a first duty cycle.

6. The method of claim 5, wherein operating the plurality of power-balancing circuits further comprises:
operating as passive rectifiers the first switch and the second switch of each power-balancing circuit not designated as the new primary power-balancing circuit.

7-11. (canceled)

12. A system comprising:
a plurality of circuit elements, wherein each circuit element is a power source that produces power or a power sink that consumes power;
a plurality of magnetically-coupled power-balancing circuits, each individual power-balancing circuit being electrically coupled in parallel to a respective circuit element and each individual power-balancing circuit including a first switch and a second switch; and
a controller coupled to each power-balancing circuit of the plurality of power-balancing circuits, the controller being configured to carry out operations comprising:
designating one power-balancing circuit of the plurality of power-balancing circuits as a primary power-balancing circuit; and
alternately toggling the first switch and the second switch of the primary power-balancing circuit in accordance with a first duty cycle.

13-17. (canceled)

18. The system of claim 12, wherein each power-balancing circuit of the plurality of power-balancing circuits comprises a respective half-bridge converter.

19. The system of claim 18, wherein each respective half-bridge converter is coupled to a single set of series-wound magnetics.

20. The system of claim 12, wherein the first duty cycle comprises a 50% duty cycle.

21. The system of claim 12, wherein each circuit element of the plurality of circuit elements is coupled together in series to form a stack.

22. The system of claim 12, wherein each circuit element of the plurality of circuit elements is electrically isolated from the other circuit elements.

23. A method comprising:
operating a plurality of circuit elements, wherein each circuit element is a power source that produces power or a power sink that consumes power; and
operating a plurality of power-balancing circuits, each individual power-balancing circuit being electrically coupled in parallel to a respective circuit element and each individual power-balancing circuit including a first switch and a second switch, wherein operating the plurality of power-balancing circuits comprises:
alternately toggling the first switch and the second switch of each power-balancing circuit such that at any given time, the first switch of each power-balancing circuit is toggled on while the second switch of each power-balancing switch is toggled off or the first switch of each power-balancing circuit is toggled off while the second switch of each power-balancing switch is toggled on.

24. The method of claim 23, wherein each power-balancing circuit of the plurality of power-balancing circuits comprises an output leg coupled between the first switch and the second switch, the output legs of two respective power-balancing circuits of the plurality of power-balancing circuits having coupled between them a capacitor.

25. The method of claim 23, wherein the first switch and the second switch of each power-balancing circuit is alternately cycled according to a duty cycle.

26. The method of claim 25, wherein the duty cycle comprises a 50% duty cycle.

27. (canceled)

28. A system comprising:
a plurality of circuit elements, wherein each circuit element is a power source that produces power or a power sink that consumes power;
a plurality of power-balancing circuits, each individual power-balancing circuit being electrically coupled in parallel to a respective circuit element and each individual power-balancing circuit including a first switch and a second switch; and
a controller coupled to each power-balancing circuit of the plurality of power-balancing circuits, the controller being configured to carry out operations comprising:
alternately toggling the first switch and the second switch of each power-balancing circuit such that at any given time, the first switch of each power-balancing circuit is toggled on while the second switch of each power-balancing switch is toggled off or the first switch of each power-balancing circuit is toggled off while the second switch of each power-balancing switch is toggled on.

29. The system of claim 28, wherein each power-balancing circuit of the plurality of power-balancing circuits comprises an output leg coupled between the first switch and the second switch, the output legs of two respective power-balancing circuits of the plurality of power-balancing circuits having coupled between them a capacitor.

30. (canceled)

31. The system of claim 30, wherein the duty cycle comprises a 50% duty cycle.

32. The system of claim 28, wherein each circuit element of the plurality of circuit elements is coupled together in series to form a stack.
